(19) United States
(12) Patent Application Publication
(10) Pub. No.: US 2023/0375664 A1
(43) Pub. Date: Nov. 23, 2023

(54) ADAPTIVE RADAR CLUTTER REMOVAL

(71) Applicant: TEXAS INSTRUMENTS INCORPORATED, Dallas, TX (US)

(72) Inventor: Anil Varghese MANI, Bengaluru (IN)

(21) Appl. No.: 17/855,467

(22) Filed: Jun. 30, 2022

(30) Foreign Application Priority Data
May 19, 2022 (IN) 202241028864

(51) Int. Cl. G01S 7/35; G01S 13/32

(52) U.S. Cl. CPC G01S 7/352; G01S 13/32

(57) ABSTRACT

A method includes, for each frame of multiple frames of radar chirps, converting each chirp return signal from a time domain to a frequency domain. The method also includes determining a mean of the chirp return signals in the frequency domain to produce a mean for each frame of the multiple frames. For each set of frames of multiple sets of frames, the method includes determining a median of the means of the set of frames. Further, the method includes reducing clutter from radar return signals using the median.

### CROSS-REFERENCE TO RELATED APPLICATIONS

This application claims priority to India Provisional Application Serial No. 202241028864, filed May 19, 2022, which is hereby incorporated by reference.

### BACKGROUND

A radio detection and ranging (“radar”) system emits microwave energy and receives and processes the reflections (“returns”). Some radar systems attempt to differentiate moving objects in an environment from stationary objects. For example, a radar-based system may attempt to count people or animals. Radar returns from stationary objects (clutter) are referred to as clutter and should be removed from the radar reflections to improve the accuracy of object counting. Unfortunately, some radar systems may confuse a slowly moving person or animal with a stationary object.

### SUMMARY

In at least one embodiment, a method includes, for each frame of multiple frames of radar chirps, converting each radar return signal from a time domain to a frequency domain. The method also includes determining a mean of the radar return signals in the frequency domain to produce a mean for each frame of the multiple frames. For each set of frames of multiple sets of frames, the method includes determining a median of the means of the set of frames. Further, the method includes reducing clutter from radar return signals using the median.

In another embodiment, an integrated circuit (IC) includes a transmitter having a transmitter input and having a receiver having a receiver output. The IC also includes an analog-to-digital converter (ADC) having an analog input and a digital output. The ADC's analog input is coupled to the receiver output. A processor is coupled to the transmitter input and to the ADC's digital output. The processor is configured to cause the transmitter to transmit multiple frames of radar chirps. For each frame of multiple frames of radar chirps, the processor is configured to receive from the ADC multiple radar return signals for each frame of the multiple frames and convert each radar return signal from a time domain to a frequency domain. The processor is also configured to determine a mean of the radar return signals in the frequency domain to produce a mean for each frame of the multiple frames. For each set of frames of multiple sets of frames, the processor is configured to determine a median of the means of the set of frames.

### BRIEF DESCRIPTION OF THE DRAWINGS

For a detailed description of various examples, reference will now be made to the accompanying drawings in which:

FIG. 1 is a block diagram of a radar system capable of removing clutter from return signals, in accordance with an embodiment.

FIG. 2 is a flow diagram illustrating the determination of the mean of multiple radar chirps within a single frame, in accordance with one or more embodiments.

FIG. 3 is a flow diagram illustrating the determination of the median of medians of multiple means of radar chirps, in accordance with one or more embodiments.

FIG. 4 is a flowchart illustrating a method for determining the median of means of means of radar chirp data, in accordance with one or more embodiments.

FIG. 5 is a flow diagram illustrating the removal of clutter from radar chirp data using the median of median of means, in accordance with one or more embodiments.

The same reference number is used in the drawings for the same or similar (either by function and/or structure) features.

### DETAILED DESCRIPTION

Embodiments are described herein of a radar system that can remove clutter from radar data. Clutter refers to radar return signals that correspond to stationary objects. By removing clutter, the remaining radar return signals generally only include non-stationary objects such as people and animals. In one use-case, the radar system may be used to count people and/or animals.

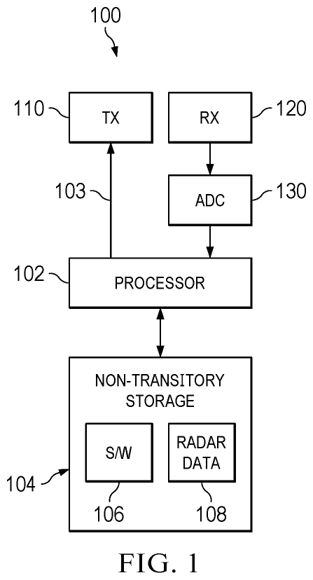

FIG. 1 is a block diagram of a radar system 100 in accordance with an example. In this example, the radar system 100 includes a processor 102, a non-transitory storage device 104, a transmitter 110, a receiver 120, and an analog-to-digital converter (ADC) 130. The processor 102, non-transitory storage device 104, transmitter 110, receiver 120, and ADC 130 may be packaged as a single device (e.g., all components shown in FIG. 1 fabricated on a common semiconductor die). The device may also have a separate digital signal processor (DSP) or other type of hardware accelerator to perform some of the processing described herein, such as Fourier transforms.

The transmitter 110 (e.g., a power amplifier) and receiver 120 (e.g., a low-noise amplifier) are capable of transmitting and receiving, respectively, radar signals (e.g., at the frequencies typical of radar signals). The processor 102 may generate an initiation signal 103 to initiate the transmitter 110 to transmit a radar signal. In the example of a frequency-modulated continuous-wave (FMCW) radar system 100, the transmitted radar signal is a “chirp.” A chirp is a signal whose frequencies increases (or decreases). In one example, the chirp emitted by the transmitter 110 is an up-chirp in that its frequency increases linearly during the transmission of the chirp. The chirp reflects off surfaces (stationary and non-stationary objects) and the return signal is received by the receiver 120 and digitized by the ADC 130. The digitized version of the return signal is provided to the processor 102 and/or stored in the non-transitory storage device 104 as radar data 108. The ADC 130 may be separate from the receiver 120 or integrated into the receiver 120 or into the processor 102. The storage device 104 also includes software 106, which is executed by the processor 102. The functionality described herein as attributed to the processor 102 may be implemented by dedicated hardware of the processor and/or general purpose hardware executing software 106.

The processor 102 processes return radar data in such a way to remove clutter from the return data. As described herein, the technique for removing clutter includes digitizing each return signal and converting the time domain digital data to the frequency domain (e.g., via a Fourier transform, for example, a Fast Fourier transform). The processor 102 causes the transmitter 110 to generate multiple radar chirps for each frame, and to generate multiple such frames. The processor 102 computes the mean of the frequency domain return data across a given frame and computes a median of the means across multiple frames. The median can then be used to remove clutter. In one example, the processor subtracts the median from each frequency domain return data, the result of which removes clutter from the return data. In another embodiment, to reduce the amount of memory (e.g., the non-transitory storage device) needed for the processing of the return data, the processor computes a median of multiple medians, and subtracts the median of medians from return data to remove clutter.

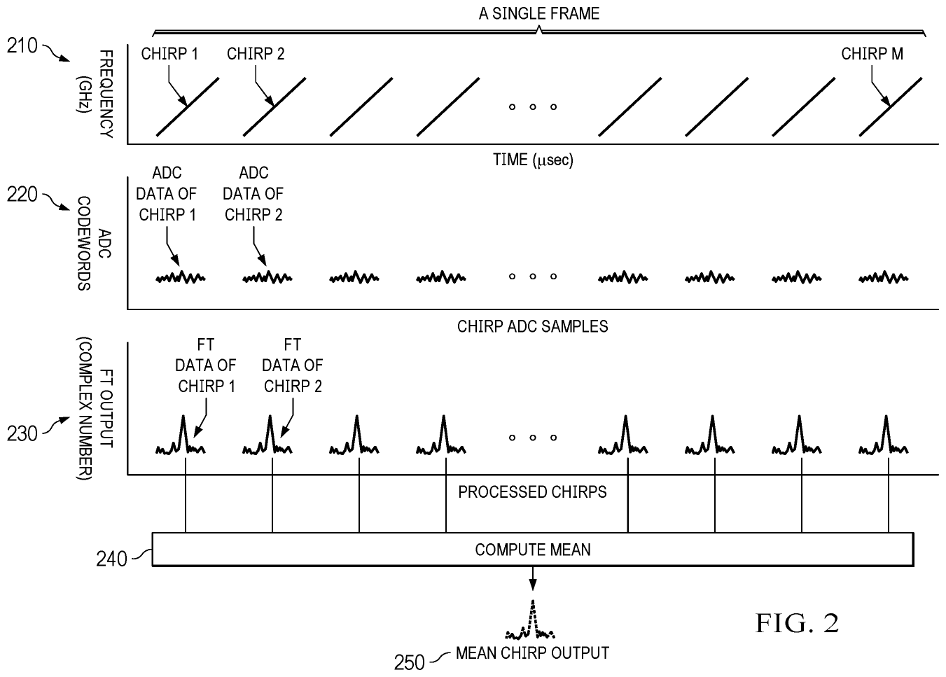

FIGS. 2-5 illustrate the above-described embodiment for removing clutter from the return radar data. Referring first to FIG. 2, a single frame 210 is shown in which M chirps are generated by the transmitter 110 in response to an initiation signal 103 from the processor 102. The X-axis for the frame 210 is time, and the Y-axis is frequency. As is illustrated, the frequency for each of the M chirps increases during the chirp. The chirps are numbered Chirp 1, Chirp 2, . . . , Chirp M. Reference numeral 220 illustrates the digital representation of the amplitude of the return data for each chirp. The ADC 130 converts the analog return signals received by receiver 120 to a digital equivalent. The processor 102 may store the digital representation of the return data in radar data 108 in the non-transitory storage medium 104.

The processor 102 converts the digital representations of the return data to the frequency domain as indicated at reference numeral 230 (x axis is frequency and y axis is the amplitude as a complex number in the frequency domain). The processor 102 may implement a Fourier transform to perform the conversion from the time domain to the frequency domain. In some examples, the Fourier transform produces a set of values for a set of frequency bins, each value indicating a magnitude of the respective frequency bin. As the frequency of an FMCW return signal corresponds to a distance between the radar system and a reflective target, each of the frequency bins may be associated with a respective range and thus may be referred to as a range bin. Because there are M chirps, there are M frequency domain representations of the return data of the M chirps for a given frame.

The processor 102 then computes the mean (as indicated at 240) of the M frequency domain radar return data to produce a mean chirp output 250. Accordingly, the processor 102 computes one mean chirp output 250 for each frame of radar chirps. In one example, a mean value is computed for each frequency bin of the frequency domain radar return data. For example, if the frequency domain radar return data 230 includes frequency bins 0, 1, 2, . . . , 127, the processor 102 computes the mean across the frequency domain data for bin 0, then bin 1, and so on. Each chirp output may be a complex number having a real component and an imaginary component for each frequency bin. The mean may be the average of the magnitudes of the complex numbers for each frequency bin, or the mean may include the average of the real components for each frequency bin and the imaginary components for each frequency bin.

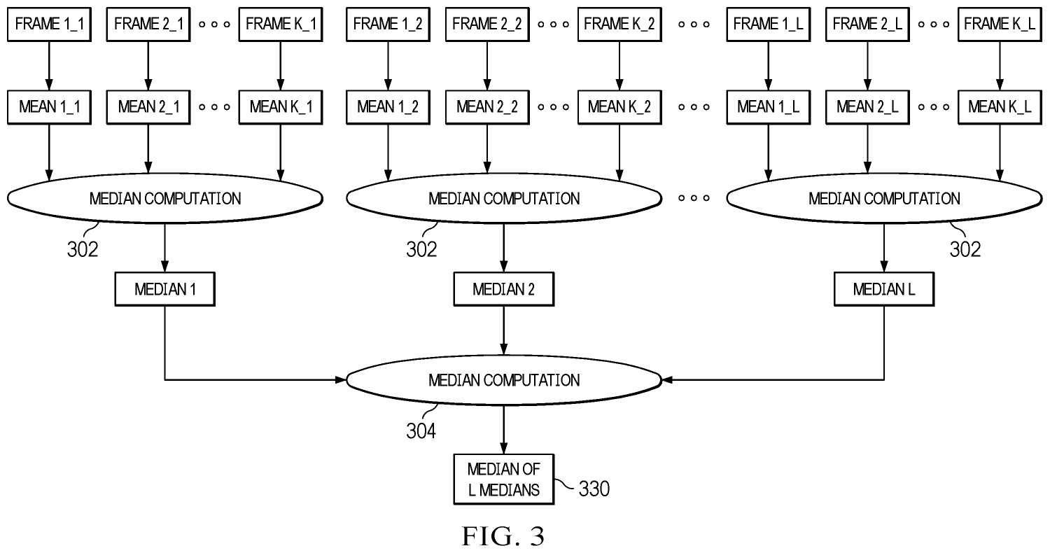

FIG. 3 illustrates further processing of the mean chirp outputs across multiple frames. FIG. 3 illustrates the processing of the means of each of K frames. Across the top of the figure and from left to right, the figure illustrates K frames numbered Frame 1_1, Frame 1_2, . . . , Frame K_1. The next set of K frames is similarly numbered but with a “_2” suffix, thus Frame 1_2, Frame 2_2, . . . , Frame K_2. FIG. 3 illustrates L sets of K frames, and the last set of K frames is numbered Frame 1_L, Fame 2_L, . . . , Frame K_L.

For each frame, the processor 102 computes a mean chirp output as described above. The mean chirp outputs are numbered similar to the frames. From left to right, the mean chirp outputs for Frame 1_1, Frame 2_1, . . . , Frame K_1 include Mean 1_1, Mean 2_1, . . . , Mean K_1. Similarly, for Frame 1_2, Frame 2_2, . . . , Frame K_2, the processor 102 computes Mean 1_2, Mean 2_2, . . . , Mean K_2. For Frame 1_L, Frame 2_L, Frame K_L, the processor 102 computes Mean 1_L, Mean 2_L, . . . , Mean K_L.

Reference numeral 302 identifies that the processor 102 computes the median of the means from the previous operations (e.g., the median of Mean 1_1, Mean 2_1, . . . , Mean K_1). The median of the means is computed on a frequency bin basis. Thus, the median of the mean data for bin 0 is determined, then the median of the mean data for bin 1 is determined, and so forth. Median 1 is the median of Mean 1_1, Mean 2_1, . . . , Mean K_1. Median 2 is the next median, and Median L is the median for the last set of means (Mean 1_L through Mean K_L). Because the frequency bin data includes complex numbers, the median of the amplitudes of the complex values (real and imaginary components) can be computed, or the medians of the real components can be computed separately from the medians of the imaginary components.

In one embodiment, the median of the means can be used to remove clutter from the return data by subtracting the median from each frequency domain representation of a return signal. If the median is of the real components is computed separately from the median of the imaginary components, the median of the real components is subtracted from the corresponding real components of the return signals, and similarly the median of the imaginary components is subtracted from the corresponding imaginary components of the return signals.

Using the median is satisfactory for this purpose, but in some examples, the results can be improved if the median is computed for a relatively large number of means. However, increasing the number of means being considered may increase the processing and storage demand. For example, K equal to 256 may result in a median that sufficiently removes clutter from radar data. However, computing the median of 256 means requires the storage in non-transitory storage device 104 of 256 means, in which each mean is, for example, a multi-point Fourier transform.

If the amount of storage capacity in the non-transitory storage device 104 is not a concern, then the computation of a signal median across a sufficiently large number of means is satisfactory for clutter removal. However, if it desirable to provide a relatively small, non-transitory storage device 104, FIG. 3 illustrates additional processing for that purpose. Another median computation 304 is computed by the processor 102 of the medians from the previous operations (e.g., Median 1, Median 2, . . . , Median L), the result of which is the median of L medians 330. The median of medians reduces the amount of memory needed because only enough storage is needed for K means. Once K means worth of data is computed for a frame and the median of those K means is computed, those K means are no longer needed and can be overwritten with the next set of K means. Thus, enough storage to concurrently store a total of L×K means not needed. The median of L medians 330 is then used to remove clutter, as described below.

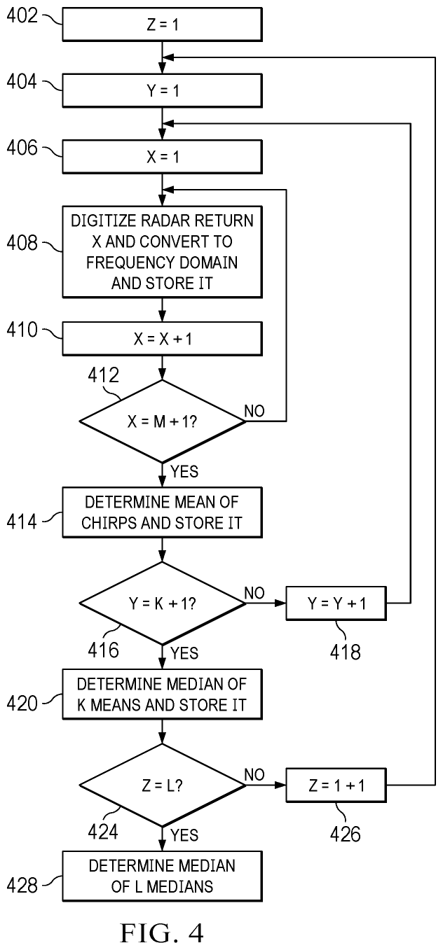

FIG. 4 is a flowchart further illustrating the above-described technique. At steps 402, 404, and 406, the processor 102 initializes three indices (Z=1, Y=1, and X=1, respectively). Index X is used to count the chirps within a given frame. Index Y is used to count the number of frames for computing the median of the means of those frames. Index Z is used to count the number of medians for computing the median of medians. At 408, the ADC 130 converts the return data for chirp X to a digital representation, and the processor 102 converts the digital representation to the frequency domain and stores the frequency domain data (e.g., in radar data 108). The index X is the incremented by the processor 102 at step 410. At step 412, the processor 102 determines whether M radar return data within the frame has been digitized and converted to the frequency domain. Control loops back to step 408 if X is less than M+1.

Upon X reaching M+1, the processor 102 then computes the mean of the X−1 (M) radar return data at step 414, and stores the mean. At step 416, the processor determines whether index Y has reached K+1. If it has not, then at step 418 the processor increments Y and control loops back to step 406 at which X is reinitialized back to 1, and the process repeats for computing the mean of the next M radar return data.

If Y has reached K+1, then the processor 102 computes the median of the Y−1 (K) means at step 420, as described above, and stores the median. If index Z also has reached its terminal value (L+1) as determined by processor 102 at step 424, then at step 428, the processor 102 also computes the median of the Z−1 medians (L medians). Otherwise, the processor 102 increments Z at step 426, and control loops back to step 404 in which Y is reinitialized to 1 (and X is reinitialized to 1 at step 406).

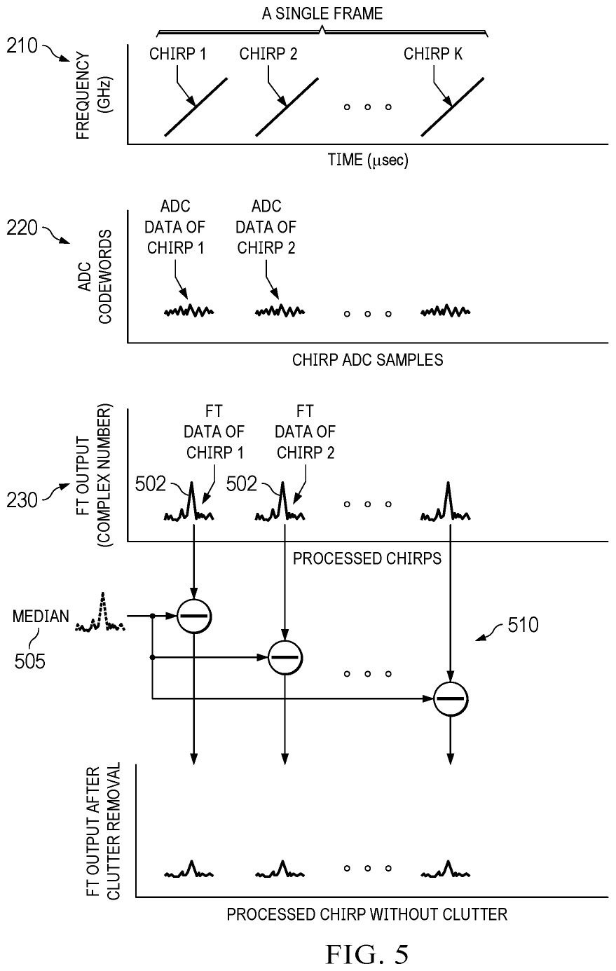

FIG. 5 illustrates the use of the computed median to remove clutter from the radar return data. At reference numeral 510, the processor 102 subtracts the median 505 from chirp return data 502, which in some examples may be future obtained return data, not the return data used to compute the median 505. In other embodiments, the chirp return data from which the median 505 is subtracted may the return data used to compute the median 505. The median 505 may be a median of a sufficiently large number of means of the frequency domain representations, or the median 505 may be the median of medians of the means as described above.

In the description, certain specific details are set forth in order to provide a thorough understanding of various disclosed implementations and embodiments. However, one skilled in the relevant art will recognize that implementations and embodiments may be practiced without one or more of these specific details, or with other methods, components, or materials.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Modifications are possible in the described embodiments, and other embodiments are possible, within the scope of the claims.

What is claimed is:

1. A method, comprising:
receiving radar data associated with transmitted radar frames each frame containing a set of radar chirps, wherein the transmitted radar frames are divided into sets of frames;
for each of the transmitted radar frames, converting a respective subset of the received radar data from a time domain to a frequency domain to produce a respective set of frequency data;
for each of the transmitted radar frames, determining a mean of the respective set of frequency data to produce a mean for each such frame;
for each set of frames of the sets of frames, determining a median of the means of the respective set of frames; and
reducing clutter from radar return signals using the median.

2. The method of claim 1, further comprising, for the sets of frames, determining a median of the medians, and wherein reducing the clutter comprises using the median of the medians.

3. The method of claim 1, wherein the respective sets of frequency data each include frequency bins, and wherein determining the median of the means comprises determining a median for each of the frequency bins.

4. The method of claim 3, wherein determining the mean for each of the transmitted radar frames includes determining a mean for each of the frequency bins of the respective set of frequency data, wherein the mean for each of the frequency bins comprises a complex number, and wherein determining the median of the means comprises determining the median of the complex numbers of the means for each of the frequency bins.

5. The method of claim 3, wherein determining the mean for each of the transmitted radar frames includes determining a mean for each of the frequency bins of the respective set of frequency data, wherein the means for each of the frequency bins comprises a complex number having a real component and an imaginary component, and wherein determining the median of the means comprises determining the median of the real components of the means for each of the frequency bins and the median of the imaginary components of the means for each of the frequency bins.

6. An integrated circuit (IC), comprising:
a transmitter having a transmitter input;
a receiver having a receiver output;
an analog-to-digital converter (ADC) having an analog input and a digital output, the analog input coupled to the receiver output;
a processor coupled to the transmitter input and to the ADC's digital output, the processor configured to:
cause the transmitter to transmit multiple frames of radar chirps;
for each frame of the multiple frames of radar chirps, from the ADC, receive multiple radar return signals and convert each radar return signal from a time domain to a frequency domain;
for each frame of the multiple frames, determine a mean of the radar return signals in the frequency domain to produce a mean for each such frame; and
for each set of frames of multiple sets of frames, determine a median of the means of the set of frames.

7. The IC of claim 6, wherein the processor is configured to reduce clutter from radar return signals using the median.

8. The IC of claim 6, wherein the processor is configured to determine, for the multiple sets of frames, a median of the medians.

9. The IC of claim 8, wherein the processor is configured to reduce clutter from radar return signal using the median of the medians.

10. The IC of claim 6, wherein the frequency domain includes multiple frequency bins, and wherein the processor is configured to determine the median of the means by determining the median for each frequency bin.

11. The IC of claim 10, wherein the means for each frequency bin comprises a complex number, and wherein the processor is configured to determine the median of the means by determining the median of the complex numbers for each frequency bin.

12. The IC of claim 10, wherein the means for each frequency bin comprises a complex number having a real component and an imaginary component, and wherein the processor is configured to determine the median of the means by determining the median of the real components of the means for each frequency and the median of the imaginary components of the means for each frequency bin.

13. A non-transitory storage device storing software that, when executed by a processor, causes the processor to:
cause a transmitter to transmit multiple frames of radar chirps;
for each frame of the multiple frames of radar chirps, receive multiple radar return signals for each frame of the multiple frames;
convert each radar return signal from a time domain to a frequency domain;
determine a mean of the radar return signals in the frequency domain to produce a mean for each frame of the multiple frames; and
for each set of frames of multiple sets of frames, determine a median of the means of the set of frames.

14. The non-transitory storage device of claim 13, wherein, when executed, the software causes the processor to reduce clutter from radar return signals using the median.

15. The non-transitory storage device of claim 13, wherein, when executed, the software causes the processor to determine, for the multiple sets of frames, a median of the medians.

16. The non-transitory storage device of claim 13, wherein, when executed, the software causes the processor to reduce clutter from radar return signal using the median of the medians.

17. The non-transitory storage device of claim 13, wherein the frequency domain includes multiple frequency bins, and wherein when executed, the software causes the processor to determine the median of the means by determining the median for each frequency bin.

18. The non-transitory storage device of claim 17, wherein the means for each frequency bin comprises a complex number, and wherein when executed, the software causes the processor to determine the median of the means by determining the median of the complex numbers for each frequency bin.

19. The non-transitory storage device of claim 17, wherein the means for each frequency bin comprises a complex number having a real component and an imaginary component, and wherein when executed, the software causes the processor to determine the median of the means by determining the median of the real components for each frequency bin and the median of the imaginary components for each frequency bin.

20. The non-transitory storage device of claim 17, wherein when executed, the software causes the processor to subtract the median from radar chirp return signals.
